(19) United States
(12) Patent Application Publication
(10) Pub. No.: US 2018/0101146 A1
(43) Pub. Date: Apr. 12, 2018

(54) ENVIRONMENT CUSTOMIZATION THROUGH LOCAL AUTOMATION SERVICES

(71) Applicant: International Business Machines Corporation, Armonk, NY (US)

(72) Inventors: Rajaraman Hariharan, Santa Clara, CA (US); Sofien Mzabi, Paris (FR); Kenechukwu C. Nwankwo, Rowlett, TX (US); Juel D. Raju, Garland, TX (US); Mathews Thomas, Flower Mound, TX (US)

(21) Appl. No.: 15/286,855

(22) Filed: Oct. 6, 2016

(51) Int. Cl. G05B 13/02; H04L 12/28

(52) U.S. Cl. CPC G05B 13/026; H04L 12/2816; G05B 13/0265

(57) ABSTRACT

Modifying an environment to meet preferred settings. Settings for controllable appliances are adjusted to customize an environment based on a profile of a user.

### BACKGROUND

The present invention relates generally to the field of control systems, and more particularly to adaptive control systems based on profile analysis.

Development of smart homes has led to automation of functions that suit needs of users. This has led to remote management of devices and systems within a house. Sensors have been developed to monitor users and systems. These sensors and systems are generic and address only a single individual.

### SUMMARY

According to an aspect of the present invention, there is a method, computer program product, and/or system that performs the following operations (not necessarily in the following order): (i) identifying a set of users in a location; (ii) determining a set of states for the set of users; (iii) determining a set of environmental settings in the location to control; (iv) adjusting the set of environmental settings based, at least in part, on: (a) the set of states, and (b) a set of profiles corresponding to the set of users. At least identifying the set of users in the location is performed by computer software running on computer hardware.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (e.g., software) portion of the first embodiment system;

FIG. 4 depicts a high-level component environment of a second embodiment of a system according to the present invention;

FIG. 5 depicts a component diagram showing a portion of the second embodiment system; and

FIG. 6 depicts a component diagram showing a portion of the second embodiment system.

### DETAILED DESCRIPTION

Modifying an environment to meet preferred settings. Settings for controllable appliances are adjusted to customize an environment based on a profile of a user. This Detailed Description section is divided into the following sub-sections: (i) Hardware and Software Environment; (ii) Example Embodiment; (iii) Further Comments and/or Embodiments; and (iv) Definitions.

### I. Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

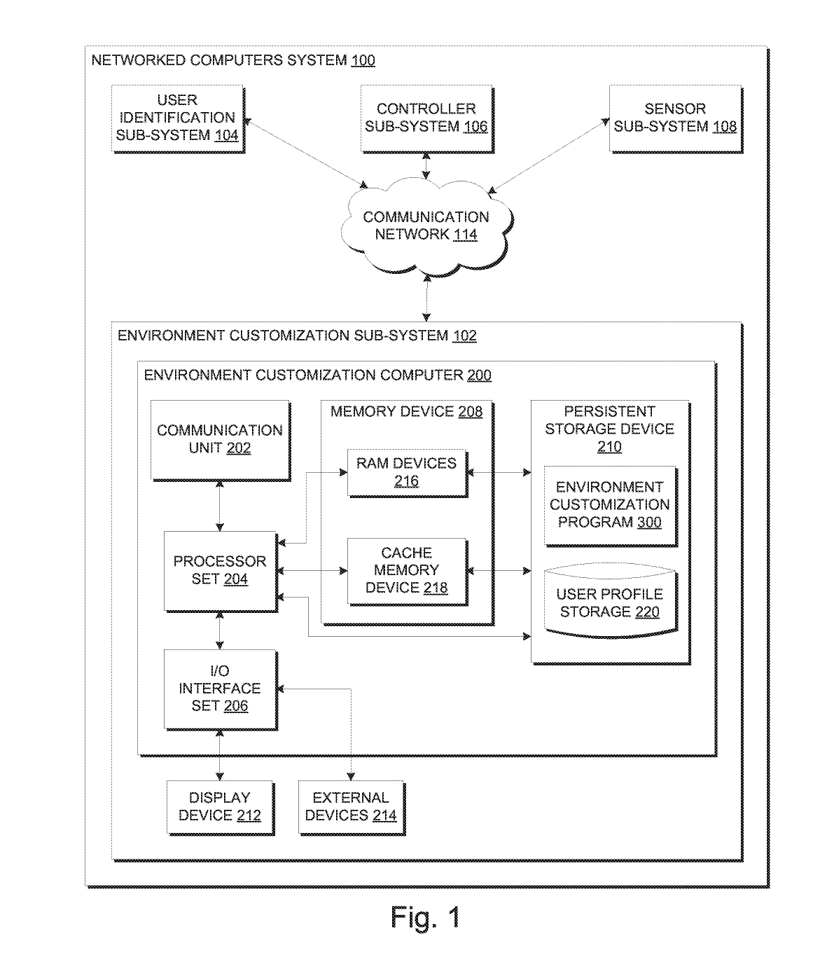

An embodiment of a possible hardware and software environment for software and/or methods according to the present invention will now be described in detail with reference to the Figures. FIG. 1 is a functional block diagram illustrating various portions of networked computers system 100, including: environment customization sub-system 102; user identification sub-system 104; controller sub-system 106; sensor sub-system 108; and communication network 114. Environment customization sub-system 102 contains: environment customization computer 200; display device 212; and external devices 214. Environment customization computer 200 contains: communication unit 202; processor set 204; input/output (I/O) interface set 206; memory device 208; and persistent storage device 210. Memory device 208 contains: random access memory (RAM) devices 216; and cache memory device 218. Persistent storage device 210 contains: user profile storage 220; and environment customization program 300.

Environment customization sub-system 102 is, in many respects, representative of the various computer sub-systems in the present invention. Accordingly, several portions of environment customization sub-system 102 will now be discussed in the following paragraphs.

Environment customization sub-system 102 may be a laptop computer, a tablet computer, a netbook computer, a personal computer (PC), a desktop computer, a personal digital assistant (PDA), a smart phone, or any programmable electronic device capable of communicating with client sub-systems via communication network 114. Environment customization program 300 is a collection of machine readable instructions and/or data that is used to create, manage, and control certain software functions that will be discussed in detail, below, in the Example Embodiment sub-section of this Detailed Description section.

Environment customization sub-system 102 is capable of communicating with other computer sub-systems via communication network 114. Communication network 114 can be, for example, a local area network (LAN), a wide area network (WAN) such as the Internet, or a combination of the two, and can include wired, wireless, or fiber optic connections. In general, communication network 114 can be any combination of connections and protocols that will support communications between environment customization sub-system 102 and client sub-systems.

Environment customization sub-system 102 is shown as a block diagram with many double arrows. These double arrows (no separate reference numerals) represent a communications fabric, which provides communications between various components of environment customization sub-system 102. This communications fabric can be implemented with any architecture designed for passing data and/or control information between processors (such as microprocessors, communications processors, and/or network processors, etc.), system memory, peripheral devices, and any other hardware components within a system. For example, the communications fabric can be implemented, at least in part, with one or more buses.

Memory device 208 and persistent storage device 210 are computer readable storage media. In general, memory device 208 can include any suitable volatile or non-volatile computer readable storage media. It is further noted that, now and/or in the near future: (i) external devices 214 may be able to supply some, or all, memory for environment customization sub-system 102; and/or (ii) devices external to environment customization sub-system 102 may be able to provide memory for environment customization sub-system 102.

User profile storage 220 may be stored in persistent storage device 210. Alternatively, user profile storage 220 may be stored in any location in communication with environment customization program 300. User profile storage 220 is a repository for profiles of users of environment customization sub-system 102.

Environment customization program 300 is stored in persistent storage device 210 for access and/or execution by one or more processors of processor set 204, usually through memory device 208. Persistent storage device 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage device 210.

Environment customization program 300 may include both substantive data (that is, the type of data stored in a database) and/or machine readable and performable instructions. In this particular embodiment (i.e., FIG. 1), persistent storage device 210 includes a magnetic hard disk drive. To name some possible variations, persistent storage device 210 may include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage device 210 may also be removable. For example, a removable hard drive may be used for persistent storage device 210. Other examples include optical and magnetic disks, thumb drives, and smart cards that are inserted into a drive for transfer onto another computer readable storage medium that is also part of persistent storage device 210.

Communication unit 202, in these examples, provides for communications with other data processing systems or devices external to environment customization sub-system 102. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communication unit 202).

I/O interface set 206 allows for input and output of data with other devices that may be connected locally in data communication with environment customization computer 200. For example, I/O interface set 206 provides a connection to external devices 214. External devices 214 will typically include devices, such as a keyboard, a keypad, a touch screen, and/or some other suitable input device. External devices 214 can also include portable computer readable storage media, such as, for example, thumb drives, portable optical or magnetic disks, and memory cards. Software and data used to practice embodiments of the present invention (e.g., environment customization program 300) can be stored on such portable computer readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

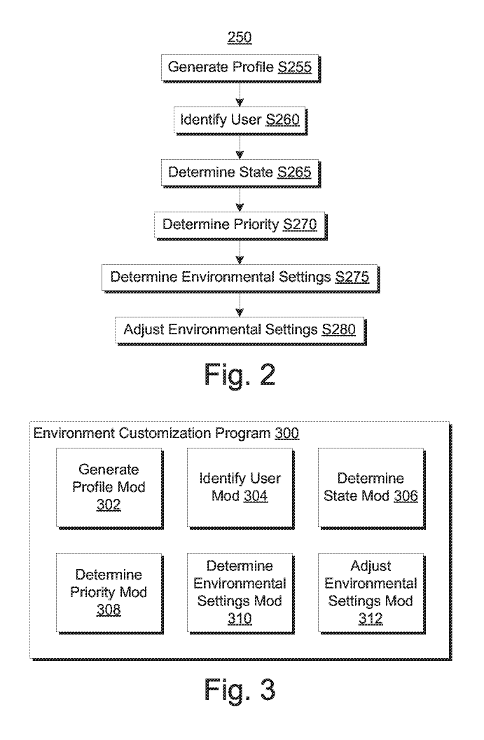

FIG. 2 shows flowchart 250 depicting a method according to the present invention. FIG. 3 shows environment customization program 300, which performs at least some of the method operations of flowchart 250. This method and associated software will now be discussed, over the course of the following paragraphs, with extensive reference to FIG. 2 (for the method operation blocks) and FIG. 3 (for the software blocks). In this example John and Ann live together in a house; John is sleeping on a couch and Ann enters the room to watch television.

Processing begins at operation S255, where generate profile module (“mod”) 302 generates a set of profiles for a set of users. In some embodiments of the present invention, generate profile mod 302 generates a set of profiles for a set of users. In some of these embodiments, generate profile mod 302 generates a set of profiles for a set of users, wherein each profile in the set of profiles includes a set of preferences corresponding to a user in the set of users. Preferences include, but are not limited to, temperature preferences, lighting preferences, sound level preferences, window shade preferences, and/or ventilation preferences (e.g., vent direction). In other embodiments, generate profile mod 302 generates a set of profiles for a set of users, wherein each profile in the set of profiles includes a set of biometric data corresponding to a user in the set of users. Biometric data include, but are not limited to, a heart rate for a user, a body temperature for a user, a blood pressure for a user, a respiratory rate for a user, facial imaging for a user, a set of fingerprints for a user. In some of these embodiments, generate profile mod 302 includes a set of medical data for a user in a profile corresponding to the user. Medical data for a user includes, but is not limited to, a current state of health for a user and/or a current illness for a user. In further embodiments, generate profile mod 302 includes a set of medical history data for a user in a profile corresponding to the user. Medical history data for a user includes, but is not limited to, a set of prior illnesses for a user and/or a set of baseline biometric data.

In some embodiments of the present invention, generate profile mod 302 generates a set of profiles for a set of users based, at least in part, on a set of inputs. In further embodiments, generate profile mod 302 receives a set of profiles for a set of users. In other embodiments, generate profile mod 302 generates a set of profiles for a set of users, wherein each profile in the set of profiles includes a set of biographical data for a user in the set of users. Biographical data include, but are not limited to, a name of a user, an age of a user, a height of a user, and/or a weight of a user. In some embodiments, generate profile mod 302 generates a set of profiles for a set of users based, at least in part, on a set of learned behaviors corresponding to the set of users. In further embodiments, generate profile mod 302 updates a set of profiles for a set of users based, at least in part, on an adaptive learning processing that learns a set of behavioral patterns corresponding to the set of users. In further embodiments of the present invention, generate profile mod 302 generates a set of profiles for a set of users by importing a set of preferences from a set of social media accounts corresponding to the set of users. In other embodiments, generate profile mod 302 generates a set of profiles for a set of users, wherein each profile in the set of profiles includes an identifier for a user in the set of users. In this example, generate profile mod 302 generates a profile for each of John and Ann. Here, each profile includes temperature and sound level settings for each of two states (sleeping and watching television). John's preferences include a sleeping state temperature of 70° F. and a sleeping state volume of 10. Ann's preferences include a watching television state temperature of 76° F. and a watching television state volume of 28.

Processing proceeds to operation S260, where identify user mod 304 identifies a set of users. In some embodiments of the present invention, identify user mod 304 identifies a set of users. In some embodiments, identify user mod 304 identifies a set of users based, at least in part, on a set of measured biometric data. In some of these embodiments, identify user mod 304 identifies a set of users based, at least in part, on a set of measured biometric data that is compared to a set of biometric data in a set of profiles. In further embodiments, identify user mod 304 identifies a set of users based, at least in part, on facial recognition. In other embodiments, identify user mod 304 identifies a set of users based, at least in part, on a user identifier. In some of these embodiments, identify user mod 304 identifies a set of users based, at least in part, on a user identifier in a wearable device. Alternatively, identify user mod 304 identifies a set of users based, at least in part on a user identifier programmed into a mobile computing device. In some embodiments, identify user mod 304 identifies a set of users upon entry of the set of users into a location. In alternative embodiments, identify user mod 304 identifies a set of users that are already in a location. In further embodiments, identify user mod 304 identifies a set of users in a location. In other embodiments, identify user mod 304 identifies a set of users in a sub-location within a location. In some embodiments, identify user mod 304 identifies a set of users for whom generate profile mod 302 generates a set of profiles in operation S255. In this example, identify user mod 304 identifies John while John is already in the room based on the fitness tracker he is wearing. Further, identify user mod 304 identifies Ann as she enters the room using a camera located in the room and facial recognition software.

Processing proceeds to operation S265, where determine state mod 306 determines a set of states for a set of users. In some embodiments of the present invention, determine state mod 306 determines a set of states for a set of users. States include, but are not limited to: a sleeping state, a watching television state, an exercising state, a relaxed state, a driving state, a sick state, a meditative state, and/or an elderly state. In some embodiments, determine state mod 306 determines a set of states for a set of users using adaptive learning. In some of these embodiments, determine state mod 306 determines a set of states for a set of users using adaptive learning based, at least in part, on a set of prior states for the set of users.

In some embodiments of the present invention, determine state mod 306 determines a set of states for a set of users using predictive analytics. In some embodiments, determine state mod 306 determines a set of states for a set of users using predictive analytics based, at least in part on a set of prior states for the set of users. In some of these embodiments, determine state mod 306 determines a set of states for a set of users based, at least in part, on predicting a set of future actions of the set of users. In other embodiments, determine state mod 306 determines a set of states for a set of users based, at least in part, on a set of movements by the set of users. In some embodiments, determine state mod 306 determines a set of states for a set of users identified by identify user mod 304 in operation S260. In this example, determine state mod 306 determines John is in a sleeping state based on John's decreased hear rate, decreased respiration rate, and lack of movement. Further, determine state mod 306 determines Ann is in a watching television state based on predictive analytics that predict Ann watches television at 3:00 pm on Saturdays.

Processing proceeds to operation S270, where determine priority mod 308 determines a set of priorities for a set of users. In some embodiments of the present invention, determine priority mod 308 determines a set of priorities for a set of users. In some embodiments, determine priority mod 308 determines a set of priorities for a set of users based, at least in part, on a set of states for a set of users. For example, a user driving a car would have a higher priority than a user riding as a passenger in the car. In other embodiments, determine priority mod 308 determines a set of priorities for a set of users based, at least in part, on an adaptive learning processing that learns a set of behavioral patterns corresponding to the set of users. In some embodiments of the present invention, determine priority mod 308 determines a set of priorities for a set of users using predictive analytics. In some embodiments, determine priority mod 308 determines a set of priorities for a set of users using predictive analytics based, at least in part on a set of prior priorities for the set of users. In some of these embodiments, determine priority mod 308 determines a set of priorities for a set of users based, at least in part, on predicting a set of future actions of the set of users.

In other embodiments, determine priority mod 308 determines a set of priorities for a set of users based, at least in part, on a set of states for the set of users. In alternative embodiments, determine priority mod 308 determines a set of priorities for a set of users by assigning a numerical priority value to each user. Alternatively, determine priority mod 308 determines a set of priorities for a set of users by assigning a qualitative priority value to each user. In some embodiments, determine priority mod 308 determines a set of priorities for a set of users, wherein a priority for a first user in the set of users is given a highest priority. In further embodiments, determine priority mod 308, determines a set of priorities for the set of users identified by identify user mod 304 in operation S260 and for whom determine state mod 306 determined a set of states in operation S265. In this example, determine priority mod 308 determines that John has a “high” priority because he is in a sleeping state and that Ann has a “normal” priority because she is in a watching television state.

Processing proceeds to operation S275, where determine environmental settings mod 310 determines a set of environmental settings to control. In some embodiments of the present invention, determine environmental settings mod 310 determines a set of environmental settings to control. In other embodiments, determine environmental settings mod 310 determines a set of environmental settings to control in a location. In further embodiments, determine environmental settings mod 310 determines a set of environmental settings to control in a sub-location within a location. Environmental settings to be controlled include, but are not limited to: lighting settings; lighting intensity; sound level; air temperature; water temperature; air vent direction; air circulation rate; and/or fan speed. In some embodiments, determine environmental settings mod 310 determines a set of environmental settings to control for a location in which identify user mod 304 identifies a set of users in operation S260. In this example, determine environmental settings mod 310 determines that a set of environmental settings to control for the room in which John is sleeping and Ann is watching television include: overhead lighting settings; overhead lighting intensity; television volume; television brightness; air temperature through a thermostat; air vent directions; and air vent speed.

Processing terminates at operation S280, where adjust environmental settings mod 312 adjusts a set of environmental settings. In some embodiments of the present invention, adjust environmental settings mod 312 adjusts a set of environmental settings. In some embodiments, adjust environmental settings mod 312 adjusts a set of environmental settings based, at least in part, on a set of preferences corresponding to a set of users. In other embodiments, adjust environmental settings mod 312 adjusts a set of environmental settings based, at least in part, on a set of preferences corresponding to user in a set of users, wherein the user has a highest priority. In further embodiments, adjust environmental settings mod 312 adjusts a set of environmental settings based, at least in part, on an average of a set of preferences corresponding to a set of users. An average of a set of preferences includes, but is not limited to, averaging a set of temperature preferences, averaging a set of lighting intensity preferences, and/or averaging a set of sound level preferences. In other embodiments, adjust environmental settings mod 312 adjusts a set of environmental settings based, at least in part, on a weighted average of a set of preferences corresponding to a set of users, wherein the weighted average is based, at least in part, on a priority.

In some embodiments, adjust environmental settings mod 312 adjusts a set of environmental settings based, at least in part, on a combination of a set of preferences corresponding to a set of users. A combination of a set of preferences includes, but is not limited to, incorporating a set of preferences of a set of users, wherein preferences of at least a first user in the set of users and a second user in the set of users are combined. For example, a first user prefers all lighting fixtures turned on at full intensity and a second user prefers all lighting fixtures turned off; to combine these preferences, adjust environmental settings mod 312: (i) turns on all lighting fixtures, but dims the lighting fixtures to half of the lighting intensity; and/or (ii) turns on half of the lighting fixtures, but increases the lighting intensity of the lighting fixtures to full intensity. In another example, adjust environmental settings mod 312: (i) alternates song selections from a set of playlists for a set of users; and/or (ii) plays a set of songs from a unified playlist for a set of users. In some embodiments, adjust environmental settings mod 312, adjusts a set of environmental settings in a location for which determine environmental settings mod 310 determined a set of environmental settings to control in operation S275 and in which identify user mod 304 identifies a set of users in operation S260, wherein the set of environmental settings are adjusted based on a set of preferences in a set of profiled for a set of users, which profiles were generated by generate profile mod 302 in operation S255. In this example, adjust environmental settings mod 312 adjusts a set of environmental settings based on a weighted average of John's preferences and Ann's preferences. Because John has a “high” priority and Ann has a “normal” priority, John's preferences are given a weighting factor of 2 and Ann's preferences are given a weighting factor of 1. Therefore, adjust environmental settings mod 312 adjusts the room temperature to 72° F., 70*2+76*1/3 , and adjusts the television volume to 16, 10*2+28*1/3.

### III. Further Comments and/or Embodiments

Some embodiments of the present invention recognize the following facts, potential problems, and/or potential areas for improvement with respect to the current state of the art: (i) environmental customization systems do not adjust for multiple users in a location; and/or (ii) environmental customization systems do not adapt to a set of users.

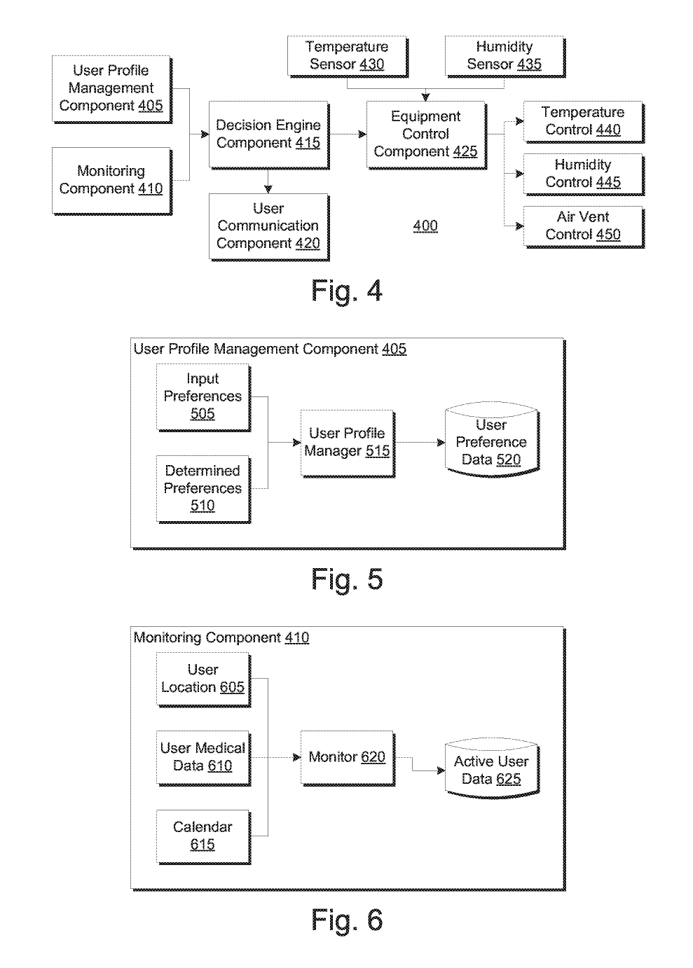

FIG. 4 depicts high-level component environment 400. High-level component environment 400 is one possible embodiment of the present invention. High-level component environment 400 includes: user profile management component 405; monitoring component 410; decision engine component 415; user communication component 420; equipment control component 425; temperature sensor 430; humidity sensor 435; temperature control 440; humidity control 445; and air vent control 450.

User profile management component 405 collects a set of information about a set of users. Some information collected by user profile management component 405 is identification information about a set of users. Some information collected by user profile management component 405 is preference information about a set of users. User profile management component 405 augments a set of profiles with collected data and/or inferred data. Additionally, user profile management component 405 updates a set of profiles for a set of users after a user input and/or a determined change in a set of preferences for the set of users. User profile management component 405 transmits a set of information about a set of users to decision engine component 415.

Monitoring component 410 monitors a set of users in a location. Monitoring component 410 further monitors a set of parameters related to a set of users in a location. A set of parameters related to a set of users includes, but is not limited to: (i) a set of biometric data for the set of users; (ii) a set of states for the set of users; (iii) a set of movements for the set of users; and/or (iv) an amount of time the set of users has been in a location. In some embodiments of the present invention, monitoring component 410 monitors a set of users on a continuous basis. In alternative embodiments, monitoring component 410 monitors a set of users on a periodic basis. In further embodiments, monitoring component 410 accesses historical data about a set of users. Monitoring component 410 further monitors a set of environmental conditions. A set of environmental conditions includes, but is not limited to: (i) a temperature; (ii) a lighting setting; (iii) a current noise level; (iv) an air quality; (v) a level of cleanliness; (vi) a set of current weather situations; (vii) a set of current weather forecasts; (viii) a set of fuel prices; and/or (ix) a set of scheduled events. In other embodiments, monitoring component 410 determines a set of control equipment in a location. In further embodiments, monitoring component 410 determines a set of functional ranges for a set of control equipment in a location. Monitoring component 410 transmits a set of information about a set of users and/or about a set of environmental conditions to decision engine component 415.

Decision engine component 415 determines a set of desired environmental settings. Decision engine component 415 receives inputs from user profile management component 405 and monitoring component 410. Decision engine component 415 resolves conflicts between preferences among a set of users. In some embodiments of the present invention, decision engine component 415 uses predictive analytics to determine a set of desired environmental settings. In further embodiments, decision engine component 415 suggests actions for a set of users to improve a set of desired environmental settings. In alternative embodiments, decision engine component 415 suggests a set of environmental control settings to achieve a set of desired environmental settings. In some embodiments, decision engine component 415 uses prescriptive analytics to determine a set of future actions for a set of users in a location. Decision engine component 415 transmits a set of information about a set of desired environmental settings to user communication component 420 and/or equipment control component 425.

User communication component 420 is a user interface component that transmits information from decision engine component 415 to a set of users. In some embodiments of the present invention, user communication component 420 receives inputs from a set of users. In some of these embodiments, user communication component 420 transmits inputs from a set of users to decision engine component 415.

Equipment control component 425 controls a set of equipment to adjust a set of environmental settings. Equipment control component 425 receives inputs from a set of sensors, including, but not limited to: temperature sensor 430; and humidity sensor 435. Equipment control component 425 transmits a set of instructions to a set of equipment controls, including, but not limited to: temperature control 440; humidity control 445; and air vent control 450. In some embodiments of the present invention, equipment control component 425 transmits a set of information from a set of sensors to decision engine component 415. In some embodiments, equipment control component 425 acts as a feedback loop, wherein equipment control component 425 adjusts a control (e.g., temperature control 440), receives feedback from a sensor (e.g., temperature sensor 430), and repeats a cycle of adjustments and feedback.

FIG. 5 depicts a component diagram of user profile management component 405. User profile management component 405 includes: input preferences 505; determined preferences 510; user profile manager 515; and user preference data 520.

Input preferences 505 are a set of preferences received as a set of inputs from a set of users. Determined preferences 510 are a set of preferences for a set of users, wherein the set of preferences are determined by environment customization sub-system 102. User profile manager 515 receives preferences from input preferences 505 and determined preferences 510 and generates a set of merged preferences. User profile manager 515 transmits a set of merged preferences to user preference data 520. User preference data 520 is a storage for a set of user preferences.

FIG. 6 depicts a component diagram of monitoring component 410. Monitoring component 410 includes: user location 605; user medical data 610; calendar 615; monitor 620; and active user data 625.

User location 605 determines a set of locations for a set of users. User medical data 610 determines a set of medical data for a set of users. Calendar 615 determines a set of events for a set of users based, at least in part, on a set of calendars. Monitor 620 receives a set of monitoring data from user location 605, user medical data 610, calendar 615, and other monitoring components. Monitor 620 generates a set of data about a set of users based, at least in part, on data received from a set of monitoring components. Monitor transmits a set of data about a set of users to active user data 625. Active user data 625 is a storage for a set of user data.

Some embodiments of the present invention may include one, or more, of the following features, characteristics, and/or advantages: (i) inferring a set of user preferences; (ii) updating a set of user profiles; (iii) updating a set of user profiles based, at least in part, on a set of inferred preferences; and/or (iv) updating a set of user profiles based, at least in part, on a set of user feedback.

Some embodiments of the present invention may include one, or more, of the following features, characteristics, and/or advantages: (i) collecting a set of medical information about a set of users; (ii) collecting a set of medical information about a set of users from a set of sensors; (iii) collecting a set of medical information about a set of users from a set of wearable sensors; (iv) collecting a set of environmental information; (v) collecting a set of environmental information from a set of sensors; (vi) collecting a set of data about a set of statuses for a set of users; and/or (vii) collecting a set of data about a set of statuses for a set of users from a calendar.

Some embodiments of the present invention may include one, or more, of the following features, characteristics, and/or advantages: (i) maintaining a set of current data; (ii) maintaining a set of historical data; (iii) gathering a set of preferences for a set of users; (iv) determining a set of controllable environmental settings; (v) gather a set of current environmental settings; (vi) gather a set of current environmental settings through a set of sensors.

Some embodiments of the present invention resolve a set of conflicts between a first set of preferences for a first user and a second set of preferences for a second user. In some embodiments, an environment customization sub-system resolves a set of conflicts between a first set of preferences for a first user and a second set of preferences for a second user. In further embodiments, an environment customization sub-system resolves a set of conflicts between a first set of preferences for a first user and a second set of preferences for a second user to determine a most comfortable set of environmental settings. In other embodiments, an environment customization sub-system proposes a set of changes to a set of preferences for a user. In alternative embodiments, an environment customization sub-system proposes a set of changes to a set of preferences for a user and collects a set of feedback from the user. In some embodiments, an environment customization sub-system updates a set of profiles for a set of users.

Some embodiments of the present invention detect a set of environmental settings in a location. In some of these embodiments, an environment customization sub-system detects a detect a set of environmental settings in a location through a set of sensors. In further embodiments, an environment customization sub-system uses a set of control equipment to maintain a set of environmental settings. In other embodiments, an environment customization sub-system determines a set of boundary conditions for a set of control equipment.

Some embodiments of the present invention may include one, or more, of the following features, characteristics, and/or advantages: (i) adjusting a set of environment conditions based, at least in part, on a set of health conditions for a set of users; (ii) adjusting a set of environment conditions based, at least in part, on a set of states for a set of users; (iii) adjusting a set of environment conditions based, at least in part, on a set of sleep cycles for a set of users; and/or (iv) determining a set of environmental settings for a location based, at least in part, on a set of preferences for a set of users.

Some embodiments of the present invention may include one, or more, of the following features, characteristics, and/or advantages: (i) decreasing energy consumption for a location based, at least in part, on an improved set of environmental settings; (ii) increasing a level of comfort for a set of users based, at least in part, on an improved set of environmental settings; (iii) identifying a set of users in various sub-locations within a location; and/or (iv) adjusting a set of environmental settings within a set of sub-locations within a location based, at least in part, on movement of a set of users.

Some embodiments of the present invention determine a set of users by detecting a user identification. In some of these embodiments, a user identification is a set of biometric data associated with a user. In other embodiments, a user identification is an alphanumeric combination associated with a user. In further embodiments, an environment customization sub-system identifies a user identification from a wearable device worn by a user. In alternative embodiments, an environment customization sub-system identifies a user identification from a first sensor in a set of sensors in a location.

Some embodiments of the present invention increase in complexity through adaptive learning and/or predictive analytics. In some embodiments of the present invention, an environment customization sub-system predicts a desired set of environmental settings for a set of users based, at least in part, on a set of historical environmental settings. In some embodiments of the present invention, an environment customization sub-system determines a desired set of environmental settings for a set of users based, at least in part, on a set of behaviors learned over a period of time.

Some embodiments of the present invention recommend environmental settings to a set of users. In some embodiments, an environment customization sub-system recommends a set of environmental settings to a set of users based, at least in part, on a cost efficiency. In other embodiments, an environment customization sub-system recommends a set of environmental settings to a set of users based, at least in part, on an energy efficiency.

In some embodiments of the present invention, an environment customization sub-system treats a subset of a set of users as a group for determination of a set of states. In other embodiments of the present invention, an environment customization sub-system treats a subset of a set of users as a group for determination of a set of priorities. In some embodiments of the present invention, an environment customization sub-system operates in a stationary location (e.g., a house, a building). In further embodiments, an environment customization sub-system operates in a mobile location (e.g., a car, a plane). In alternative embodiments, an environment customization sub-system prompts a set of users to accept a set of environmental settings. In further embodiments, an environment customization sub-system determines a user in a set of users will remain in a location for a short period of time relative to other users in the set of users. In some of these embodiments, an environment customization sub-system determines a user in a set of users will remain in a location for a short period of time relative to other users in the set of users and does not incorporate a set of preferences of the user when determining a set of environmental settings. In some embodiments, an environment customization sub-system uses predictive analytics to determine a set of users will enter a location at a future time and adapts a set of environmental settings in the location to a set of preferences for the set of users.

### IV. Definitions

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Electrically connected” means either indirectly electrically connected such that intervening elements are present or directly electrically connected. An “electrical connection” may include, but need not be limited to, elements such as capacitors, inductors, transformers, vacuum tubes, and the like.

“Mechanically connected” means either indirect mechanical connections made through intermediate components or direct mechanical connections. “Mechanically connected” includes rigid mechanical connections as well as mechanical connection that allows for relative motion between the mechanically connected components. “Mechanically connected” includes, but is not limited to: welded connections; solder connections; connections by fasteners (e.g., nails, bolts, screws, nuts, hook-and-loop fasteners, knots, rivets, quick-release connections, latches, and/or magnetic connections); force fit connections; friction fit connections; connections secured by engagement caused by gravitational forces; pivoting or rotatable connections; and/or slidable mechanical connections.

A “data communication” includes, but is not necessarily limited to, any sort of data communication scheme now known or to be developed in the future. “Data communications” include, but are not necessarily limited to: wireless communication; wired communication; and/or communication routes that have wireless and wired portions. A “data communication” is not necessarily limited to: (i) direct data communication; (ii) indirect data communication; and/or (iii) data communication where the format, packetization status, medium, encryption status, and/or protocol remains constant over the entire course of the data communication.

The phrase “without substantial human intervention” means a process that occurs automatically (often by operation of machine logic, such as software) with little or no human input. Some examples that involve “no substantial human intervention” include: (i) a computer is performing complex processing and a human switches the computer to an alternative power supply due to an outage of grid power so that processing continues uninterrupted; (ii) a computer is about to perform resource intensive processing and a human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

“Automatically” means “without any human intervention.”

The term “real time” (and the adjective “real-time”) includes any time frame of sufficiently short duration as to provide reasonable response time for information processing as described. Additionally, the term “real time” (and the adjective “real-time”) includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

What is claimed is:

1. A method comprising:
identifying a set of users in a location;
determining a set of states for the set of users;
determining a set of environmental settings in the location to control; and
adjusting the set of environmental settings based, at least in part, on:
the set of states, and
a set of profiles corresponding to the set of users;
wherein:
at least identifying the set of users in the location is performed by computer software running on computer hardware.

2. The method of claim 1, further comprising:
determining a set of priorities corresponding to the set of users;
wherein:
adjusting the set of environmental settings is further based on the set of priorities.

3. The method of claim 2, wherein determining the set of priorities corresponding to the set of users includes:
predicting a set of future states for the set of users based, at least in part, on:
a set of historical data for the set of users, and
predictive analytics.

4. The method of claim 1, wherein:
each user in the set of users has a profile in the set of profiles;
each profile in the set of profiles includes a user identifier; and
identifying the set of users in the location is based, at least in part, on a set of user identifiers.

5. The method of claim 4, wherein the set of user identifiers are stored on a set of wearable devices.

6. The method of claim 1, wherein adjusting the set of environmental settings includes:
predicting a set of future states for the set of users based, at least in part, on:
a set of historical data for the set of users, and
predictive analytics.

7. The method of claim 1, wherein determining the set of states for the set of users is based, at least in part, on:
a set of historical data for the set of users, and
adaptive learning.

8. A computer program product comprising:
a computer readable storage medium having stored thereon:
first instructions executable by a device to cause the device to identify a set of users in a location;
second instructions executable by a device to cause the device to determine a set of states for the set of users;
third instructions executable by a device to cause the device to determine a set of environmental settings in the location to control; and
fourth instructions executable by a device to cause the device to adjust the set of environmental settings based, at least in part, on:
the set of states, and
a set of profiles corresponding to the set of users.

9. The computer program product of claim 8, further comprising:
fifth instructions executable by a device to cause the device to determine a set of priorities corresponding to the set of users;
wherein:
fourth instructions adjust the set of environmental settings is further based on the set of priorities.

10. The computer program product of claim 9, wherein fifth instructions to determine the set of priorities corresponding to the set of users include:
sixth instructions executable by a device to cause the device to predict a set of future states for the set of users based, at least in part, on:
a set of historical data for the set of users, and
predictive analytics.

11. The computer program product of claim 8, wherein:
each user in the set of users has a profile in the set of profiles;
each profile in the set of profiles includes a user identifier; and
first instructions to identify the set of users in the location is based, at least in part, on a set of user identifiers.

12. The computer program product of claim 11, wherein the set of user identifiers are stored on a set of wearable devices.

13. The computer program product of claim 8, wherein fourth instructions to adjust the set of environmental settings include:
fifth instructions executable by a device to cause the device to predict a set of future states for the set of users based, at least in part, on:
a set of historical data for the set of users, and
predictive analytics.

14. The computer program product of claim 8, wherein second instructions to determine the set of states for the set of users is based, at least in part, on:
a set of historical data for the set of users, and
adaptive learning.

15. A computer system comprising:
a processor set; and
a computer readable storage medium;
wherein:
the processor set is structured, located, connected, and/or programmed to execute instructions stored on the computer readable storage medium; and
the instructions include:
first instructions executable by a device to cause the device to identify a set of users in a location;
second instructions executable by a device to cause the device to determine a set of states for the set of users;
third instructions executable by a device to cause the device to determine a set of environmental settings in the location to control; and
fourth instructions executable by a device to cause the device to adjust the set of environmental settings based, at least in part, on:
the set of states, and
a set of profiles corresponding to the set of users.

16. The computer system of claim 15, further comprising:
fifth instructions executable by a device to cause the device to determine a set of priorities corresponding to the set of users;
wherein:
fourth instructions adjust the set of environmental settings is further based on the set of priorities.

17. The computer system of claim 16, wherein fifth instructions to determine the set of priorities corresponding to the set of users include:
sixth instructions executable by a device to cause the device to predict a set of future states for the set of users based, at least in part, on:
a set of historical data for the set of users, and
predictive analytics.

18. The computer system of claim 15, wherein:
each user in the set of users has a profile in the set of profiles;
each profile in the set of profiles includes a user identifier; and
first instructions to identify the set of users in the location is based, at least in part, on a set of user identifiers.

19. The computer system of claim 15, wherein fourth instructions to adjust the set of environmental settings include:
fifth instructions executable by a device to cause the device to predict a set of future states for the set of users based, at least in part, on:
a set of historical data for the set of users, and
predictive analytics.

20. The computer system of claim 15, wherein second instructions to determine the set of states for the set of users is based, at least in part, on:
a set of historical data for the set of users, and
adaptive learning.
